(19) United States
(12) Patent Application Publication
(10) Pub. No.: US 2008/0229598 A1
(43) Pub. Date: Sep. 25, 2008

(54) Multi-function measuring tool

(76) Inventor: Hsu Hsiu-Kwei Liu, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/727,197

(22) Filed: Mar. 23, 2007

(51) Int. Cl. G01B 3/00; B43L 7/00; G01B 3/14

(52) U.S. Cl. 33/562; 33/485

(57) ABSTRACT

A multi-function measuring tool includes a main body having a longitudinal slide way provided on a front central area, a plurality of V-notches of different angles provided at two upper lateral edges, and a plurality of straight slots of different depths perpendicularly provided at two lower lateral edges; and a ruler slidably assembled to the slide way of the main body via a set of engaged screw and nut, and having a forward projected size-reduced head portion. For example, the V-notches are used to measure the angle of a saw tooth or a cutting angle of a lathe tool, and the straight slots to measure the height and depth of a saw tooth and the milling depth of a milling cutter, and the ruler to measure a bore depth on a workpiece.

### FIELD OF THE INVENTION

The present invention relates to a measuring tool, and more particularly to a multi-function measuring tool designed to measuring sizes of different cutting tools, such as the height and depth of a saw tooth on a blade, the cutting angle of a lathe tool, the milling depth of a milling cutter, or a bore depth on a workpiece.

### BACKGROUND OF THE INVENTION

There are various kinds of differently shaped measuring tools available in the market for measuring the sizes of various cutting tools. However, these conventional measuring tools are usually designed to have only one measuring function. For example, when a user wants to measure the height and the depth of a saw tooth on a blade, and the cutting angle of a lathe tool, he has to use at least three different measuring tools to separately measure the saw tooth height, the saw tooth depth, and the cutting angle of the lathe tool. That is, the user has to purchase and prepare three different measuring tools to complete the measuring work at relatively high tool cost. Moreover, these measuring tools occupy a relatively large space and are therefore not convenient for carrying and storage. It is also troublesome to manage many different measuring tools. The user requires more time to locate the necessary one from a large number of different measuring tools.

It is therefore tried by the inventor to develop a multi-function measuring tool to eliminate the drawbacks in the conventional measuring tools and allow users to do measuring work more easily.

### SUMMARY OF THE INVENTION

A primary object of the present invention is to provide a multi-function measuring tool that allows a user to use only one measuring tool to conveniently do different measuring works, such as measuring the height and depth of a saw tooth on a blade, the cutting angle of a lathe tool, the milling depth of a milling cutter, or a bore depth on a workpiece.

The multi-function measuring tool of the present invention has a small volume without occupying too much space, and is therefore easy to carry and store. A user needs to buy only one multi-function measuring tool to complete different measuring works at reduced tool cost. The multi-function measuring tool of the present invention is therefore cost-effective and practical for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a multi-function measuring tool according to the present invention;

FIG. 2 is an assembled view of FIG. 1;

FIG. 3 shows the multi-function measuring tool of the present invention is used to measure the height of a saw tooth on a blade;

FIG. 4 shows the multi-function measuring tool of the present invention is used to measure the depth of a saw tooth on a blade;

FIG. 5 shows the multi-function measuring tool of the present invention is used to measure the cutting angle of a lathe tool;

FIG. 6 shows the multi-function measuring tool of the present invention is used to measure the height of a milling cutter;

FIG. 7 shows the multi-function measuring tool of the present invention is used to measure the depth of a bore having a relatively large inner diameter; and

FIG. 8 shows the multi-function measuring tool of the present invention is used to measure the depth of a bore having a relatively small inner diameter.

### DETAILED DESCRIPTION OF THE PREFERRED EMBODIMENTS

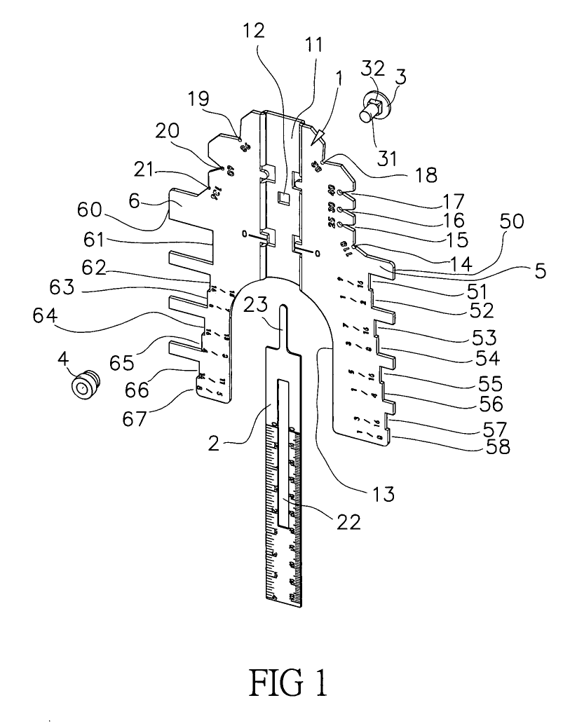

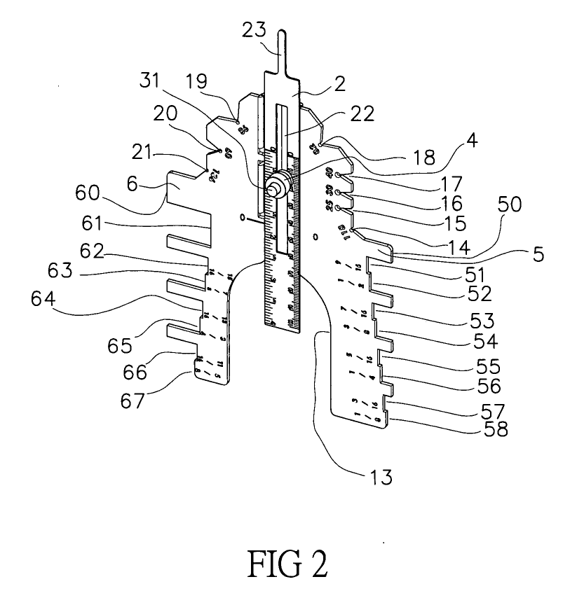

Please refer to FIGS. 1 and 2 that are exploded and assembled perspective views, respectively, of a multi-function measuring tool according to the present invention. As shown, the multi-function measuring tool includes a main body 1, a ruler 2, a screw 3, and a nut 4.

The main body 1 is made of a thin sheet material, and generally divided into an upper and a lower part. On a front central area of the upper part of the main body 1, there is formed of a longitudinally extended recessed slide way 11 with a square through hole 12 formed near a middle point thereof. The lower part of the main body 1 is provided with an open-bottomed cut 13 having a predetermined depth.

Two lateral edges of the upper part of the main body 1 are provided with a plurality of V-notches 14, 15, 16, 17, 18, 19, 20, and 21, which sequentially have an angle of 118°, 25°, 30°, 40°, 82°, 98°, 60°, and 136°. All these angular sizes are frequently used on different cutting tools and milling cutters. And, areas 5, 6 of the lower part of the main body 1 at two lateral sides of the open-bottomed cut 13 define two lateral outer edges 50, 60 that are used as two reference edges on the main body 1. Two groups of straight slots 51, 52, 53, 54, 55, 56, 57, and 58, and 61, 62, 63, 64, 65, 66, and 67 are provided along and perpendicular to the two reference edges 50, 60, respectively. The straight slots 51 through 58 and 61 through 67 in the two groups have different depths from the reference edges 50, 60. More specifically, the group of straight slots 51 through 58 sequentially has a depth of 9/16″, ½″, 7/16″, ⅜″, 5/16″, ¼″, 3/16″, and ⅛″; and the other group of straight slots 61 through 67 sequentially has a depth of 1″, 15/16″, ⅞″, 13/16″, ¾″, 11/16″, and ⅝″. All these sizes are frequently used on different cutting tools and milling cutters.

The ruler 2 is provided at a central area with a longitudinally extended long slot 22, which has a width slightly smaller than an outer diameter of the nut 4, and at an upper end with a centered and forward projected size-reduced head portion 23.

The screw 3 has a shank 31, a bottom of which is formed into a square seat 32 having a size identical to that of the square through hole 12 in the slide way 11 on the upper part of the main body 1.

To ruler 2 may be assembled to the main body 1 by sequentially extending the shank 31 of the screw 3 through the square through hole 12 on the main body 1 and the long slot 22 on the ruler 2, and tightening the nut 4 against the screw 3. It is noted the screw 3 is extended through the main body 1 with the square seat 32 of the shank 31 fitly engaged with the square through hole 12 to prevent the main body 1 from turning relative to the ruler 2. When the nut 4 is loosely tightened against the screw 3, the ruler 2 is allowed to slide forward and rearward in the slide way 11 in the upper part of the main body 1 while a rear portion of the ruler 2 is linearly movably located in the open-bottomed cut 13 in the lower part of the main body 1. When the nut 4 is fully tightened against the screw 3, the ruler 2 is fixedly held to the main body 1 for measuring.

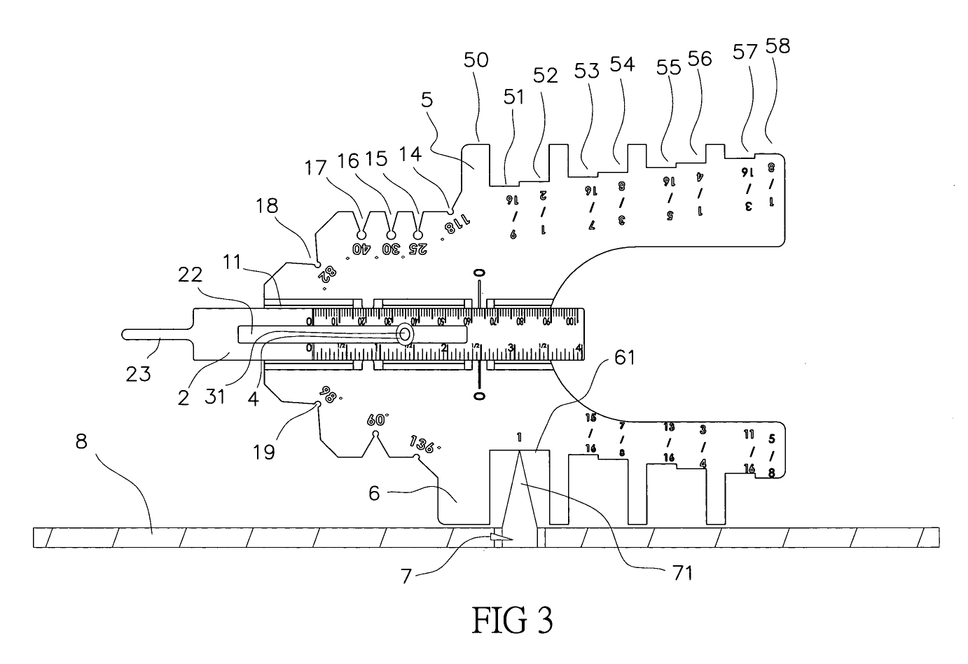

The multi-function measuring tool of the present invention may be used to measure the height of a saw tooth 71 on a blade 7. To do so, the measuring tool is horizontally laid to bear the reference edge 50 or 60 at the lower part of the main body 1 on a top surface of a workbench 8 to straddle the blade 7, as shown in FIG. 3. When the saw tooth 71 has a tip fitly in contact with an inner end of one of the straight slots 51 through 58 and 61 through 67, the height of the saw tooth 71 is quickly measured and determined according to the depth of that straight slot.

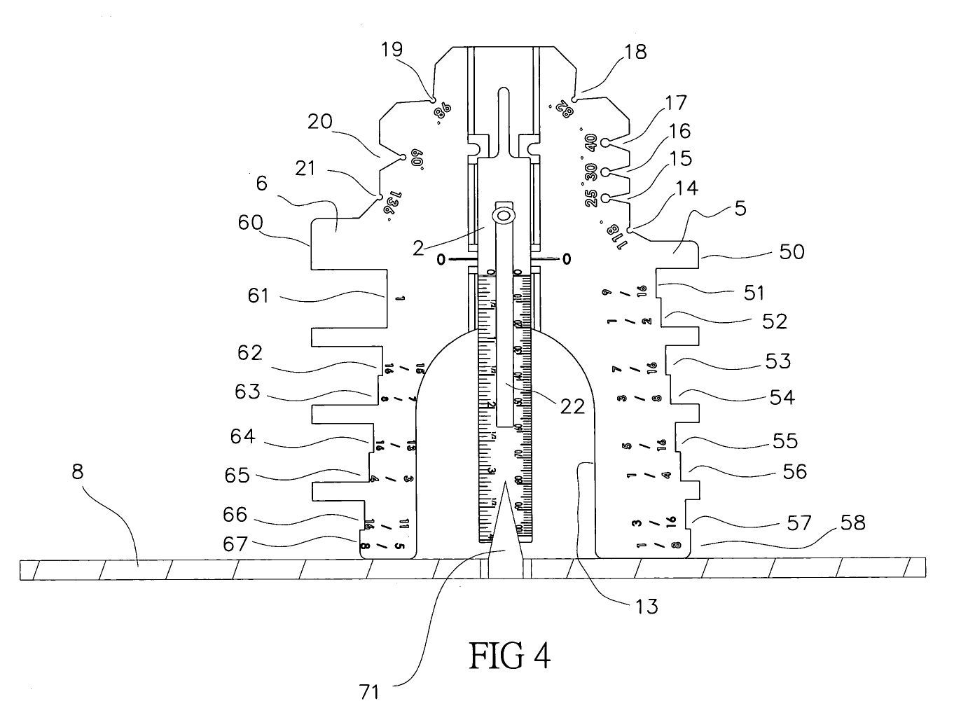

The multi-function measuring tool of the present invention may also be used to measure the depth of the saw tooth 71 on the blade 7. To do so, simply position the main body 1 on the workbench 8 with the lower part of the main body 1 straddling the blade 7, as shown in FIG. 4. Then, loosen the nut 4 and move the ruler 2 downward until a rear edge of the ruler 2 is in contact with a joint of two adjacent saw teeth 71, and the depth of the saw tooth 71 maybe quickly measured and determined from marks on the ruler 2.

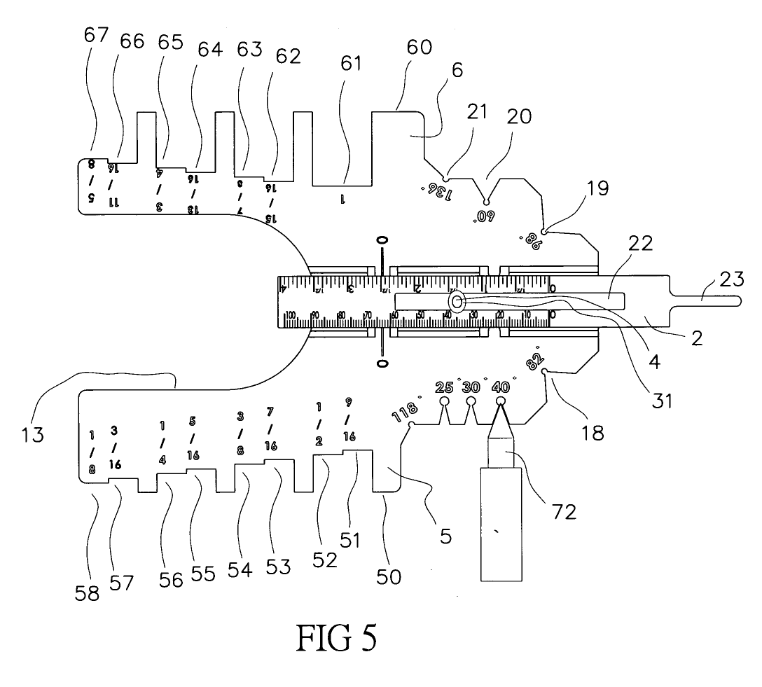

The multi-function measuring tool of the present invention may also be used to measure the angle of the saw tooth 71 or the cutting angle of a lathe tool 72. To do this, simply insert the tip of the saw tooth 71 or the edge of the lathe tool 72 in the V-notches 14 through 21 as shown in FIG. 5, and the angle of the saw tooth 71 or the cutting angle of the lathe tool 72 may be quickly determined from the V-notch that fitly engages with the tip of the saw tooth 71 or the edge of the lathe tool 72.

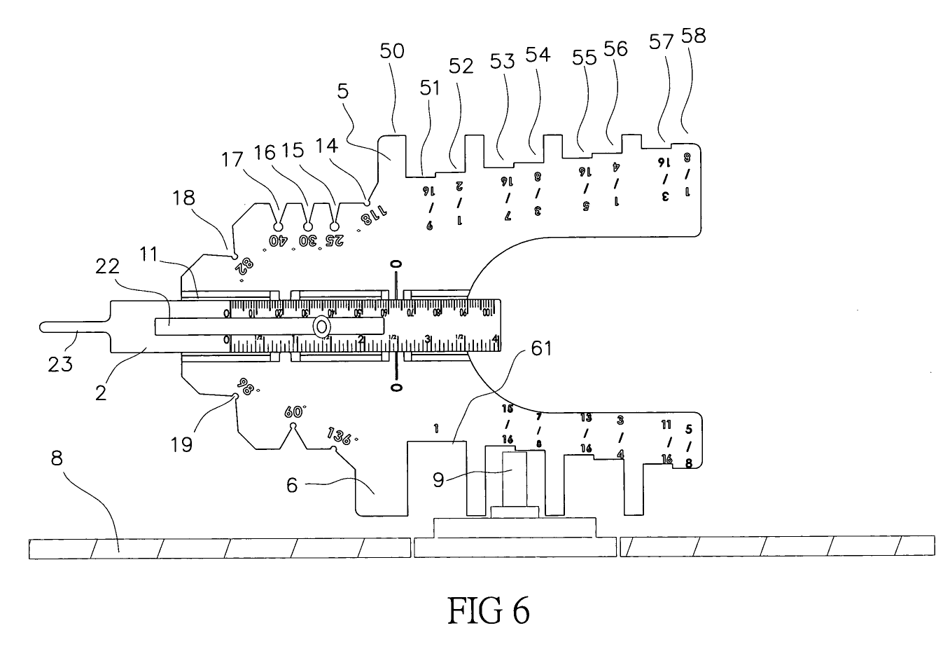

FIG. 6 shows the multi-function measuring tool of the present invention is used to measure the height of a milling cutter 9.

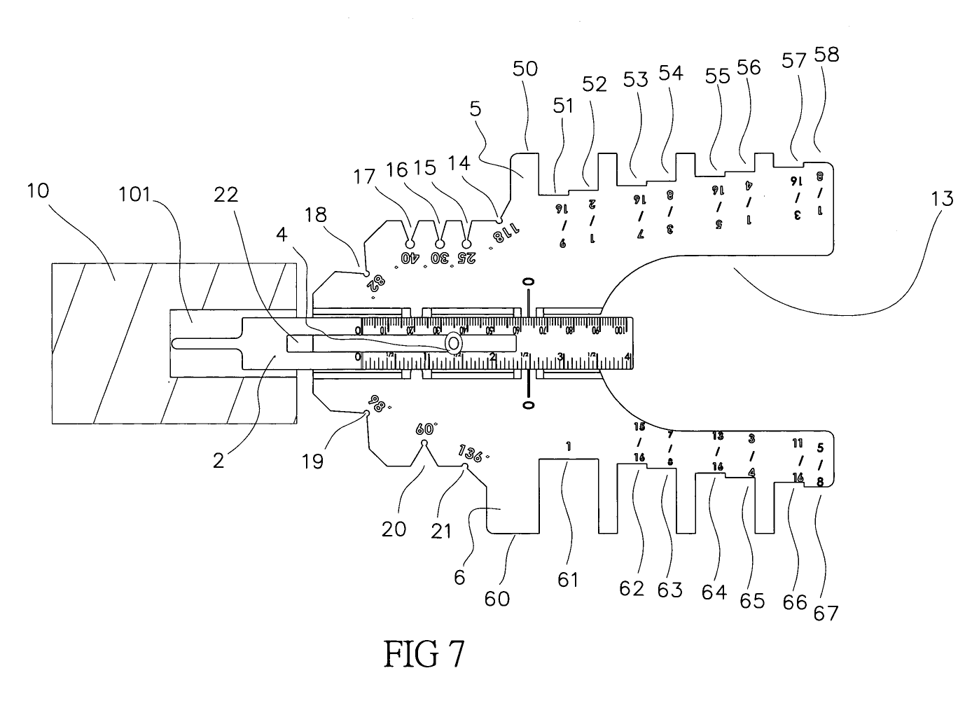

FIG. 7 shows the multi-function measuring tool of the present invention is used to measure the depth of a bore 101 on a workpiece 10 when the bore 101 has a relatively large inner diameter. To do this, simply slide the ruler 2 forward to fully extend the forward projected head portion 23 and two lateral edges of the ruler 2 behind the head portion 23 into the bore 101.

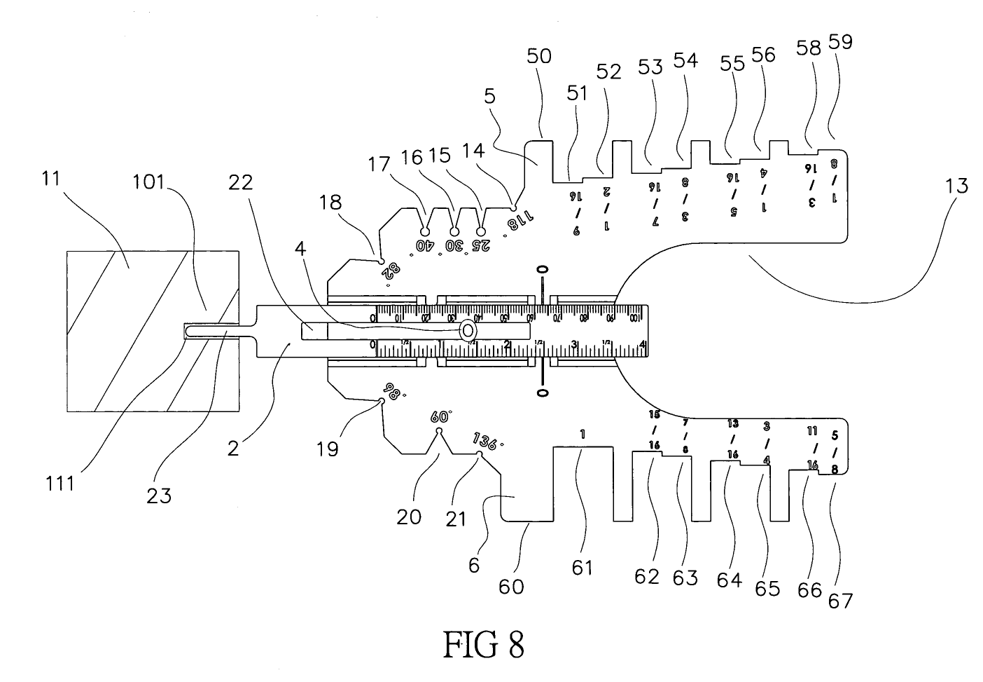

FIG. 8 shows the multi-function measuring tool of the present invention is used to measure the depth of a bore 112 on a workpiece 111 when the bore 112 has a relatively small inner diameter. To do this, simply slide the ruler 2 forward to insert the projected head portion 23 of the ruler 2 into the bore 112 to measure the depth of the bore 112.

With the above arrangements, the multi-function measuring tool according to the present invention is very convenient for use.

What is claimed is:

1. A multi-function measuring tool, comprising a main body, a ruler, a screw, and a nut; the main body being made of a thin sheet material and having an upper part and a lower part, and the upper part of the main body being provided on a front central area with a longitudinally extended recessed slide way.

2. The multi-function measuring tool as claimed in claim 1, wherein the main body is provided near a middle point of the slide way with a square through hole.

3. The multi-function measuring tool as claimed in claim 1, where in the lower part of the main body 1 is provided with an open-bottomed cut having a predetermined depth.

4. The multi-function measuring tool as claimed in claim 1, wherein the upper part of the main body is provided at two lateral edges with a plurality of V-notches that have different angular sizes.

5. The multi-function measuring tool as claimed in claim 4, wherein two lateral sides of the lower part of the main body define two lateral outer edges that are used as two reference edges on the main body.

6. The multi-function measuring tool as claimed in claim 5, wherein the main body are provided along and perpendicular to each of the two reference edges with a plurality of straight slots that have different depths from a corresponding one of the two reference edges.

7. The multi-function measuring tool as claimed in claim 1, wherein the ruler is provided at a central area with a longitudinally extended long slot, which has a width slightly smaller than an outer diameter of the nut.

8. The multi-function measuring tool as claimed in claim 1, wherein the ruler is provided at an upper end with a centered and forward projected size-reduced head portion.

9. The multi-function measuring tool as claimed in claim 1, wherein the screw includes a shank, and the shank has a bottom portion formed into a square seat.
